(19) United States
(12) Patent Application Publication
(10) Pub. No.: US 2022/0214954 A1
(43) Pub. Date: Jul. 7, 2022

(54) ELECTRONIC DEVICE FOR USE IN AN AUTOMATION SYSTEM, AND AN AUTOMATION SYSTEM

(71) Applicant: Phoenix Contact GmbH & Co. KG, Blomberg (DE)

(72) Inventor: Florian Bergmann, Holzminden (DE)

(21) Appl. No.: 17/274,079

(22) PCT Filed: Sep. 4, 2019
(86) PCT No.: PCT/EP2019/073618

§ 371 Date: Mar. 5, 2021

(30) Foreign Application Priority Data
Sep. 7, 2018 (DE) 10 2018 121 885.0

(51) Int. Cl. G06F 11/30; G06F 11/10

(52) U.S. Cl. CPC G06F 11/3037; G06F 11/1076

(57) ABSTRACT

An electronic device for use in an automation system, includes at least two device-internal digital memory cards which redundantly store data. The electronic device further includes a control and/or evaluation unit that is adapted to communicate with the at least two memory cards such that proper operation of the electronic device is ensured in the event of failure of one of the two memory cards.

### FIELD

The invention relates to an electronic device for use in an automation system, in particular a building technology automation system or an industrial automation system, and to such an automation system.

10

### BACKGROUND

To provide for a higher level of fail-safety, Redundant Area of Independent Discs (RAID) systems are employed, for example, which are used to operate a plurality of physical mass storage devices such as hard disk drives or SSD drives that store data redundantly.

15

### SUMMARY

The invention is based on the object of reducing the risk of failure of an automation system in a cost-effective and flexible manner.

What can be considered as a key idea of the invention is that data are not redundantly stored in physical mass storage devices which form a central storage system, but rather are redundantly stored in memory cards, preferably in each electronic device of an automation system. Thereby, the risk of system failure is reduced by reducing the failure probability of every electronic device in the automation system. In this way, the risk of system failure can be kept low even when further electronic devices adapted according to the invention are installed in the automation system.

The technical problem stated above is solved by the features of claim 1, on the one hand.

Accordingly, an electronic device is provided for use in an automation system, which device comprises at least two device-internal digital memory cards which redundantly store data for operating the electronic device, and a control and/or evaluation unit which is adapted to communicate with the at least two memory cards and to ensure proper operation of the electronic device even in the event of failure of one of the memory cards.

The feature “in the event of failure of one of the memory cards” does not exclude the possibility that more than one of the memory cards can fail when more than two memory cards are used. One error-free memory card is sufficient for proper operation of the electronic device.

According to an advantageous embodiment, the electronic device is a field bus subscriber, in particular a control device or a bus coupler or a sensor or an actuator. The control device may be a programmable logic controller (PLC).

In order to be able to respond to errors relating to the at least two memory cards, the control and/or evaluation unit is advantageously adapted to monitor the at least two memory cards for errors, to detect an error, and to signal the detected error.

15

Communication between the at least two memory cards and the control and/or evaluation unit preferably is performed via a serial or a parallel data bus. For example, the Serial Peripheral Interface (SPI) bus can be used as a serial bus.

Appropriately, the memory cards are provided in the form of SD memory cards.

The technical problem stated above is furthermore solved by the features of claim 6.

Accordingly, an automation system is provided, which comprises a plurality of the electronic devices as described above and a bus system to which the electronic devices are connected.

The bus system is preferably a field bus.

Appropriately, each electronic device is adapted to signal, to a higher-level control unit, an error relating to the at least two digital memory cards, and the higher-level control unit is appropriately assigned to a management level.

### BRIEF DESCRIPTION OF THE DRAWING

The invention will now be explained in more detail by way of an exemplary embodiment in conjunction with a single drawing, wherein:

FIG. 1 is a block diagram of an exemplary embodiment of an automation system.

5

### DETAILED DESCRIPTION

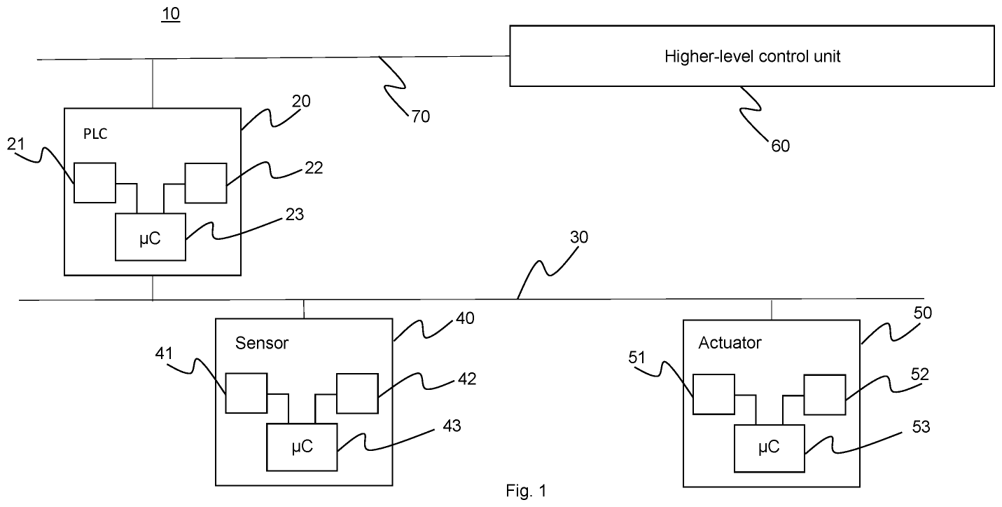

FIG. 1 shows an automation system 10 which may be in the form of a building technology automation system or an industrial automation system. As a transfer system, the automation system 10 preferably comprises a bus system, in the present example a field bus 30, to which a plurality of electronic devices in the form of field bus subscribers can be connected. A field bus subscriber may, for example, be in the form of a control device or a bus coupler or a sensor or an actuator.

In the exemplary automation system 10, the field bus 30 has connected thereto a sensor 40, an actuator 50, and a control device 20 which may be a programmable logic controller, for example. The PLC 20 may communicate with a higher-level control unit 60 via an Ethernet link 70, for example.

Each of the electronic devices 20, 40, and 50 connected to the fieldbus 30 includes at least two device-internal digital memory cards which redundantly store data for operating the respective electronic device, and a control and/or evaluation unit that is adapted to communicate with the at least two memory cards of the respective electronic device and to ensure proper operation of the respective electronic device even in the event of failure of one of the memory cards.

Thus, the sensor 40 comprises a control and/or evaluation unit 43 which may be in the form of a microcontroller. Sensor 40 may be a temperature sensor, for example, which can transmit temperature data to the control device 20. The control and evaluation unit 43 is connected to at least two device-internal digital memory cards 41 and 42 which redundantly store at least data for operating the sensor 40. Accordingly, these data are preferably data of a control program. The control and evaluation unit 43 is programmed so as to be able to access the data that are redundantly stored in the two memory cards 41 and 42 in such a way that the sensor 40 is able to continue to work properly even if one of the memory cards 41 or 42 fails. This also means that a defective memory card can be replaced during operation. The memory cards 41 and 42 may additionally redundantly store device-specific data, configuration data, and measurement data of the sensor 40. Memory cards 41 and 42 may be SD cards. Control and evaluation unit 43 can preferably communicate with the at least two memory cards 41 and 42 via a serial bus, such as the SPI bus, or via a parallel bus. The control and/or evaluation unit 43 may appropriately furthermore be adapted to monitor the at least two memory cards 41 and 42 for errors, to detect an error, and to signal the detected error to the higher-level control unit 60, for example. In this way, the higher-level control unit 60 can in particular be notified about the failure of one of the memory cards 41 or 42. An error detected by the control and evaluation unit 43 can preferably be transmitted via field bus 30 to control device 20 and can then be forwarded to the higher-level control unit 60, for evaluation. It is also conceivable that an error detected by the control and evaluation unit 43 is transmitted directly to the higher-level control unit 60 for evaluation, i.e. by bypassing the field bus 30, for example via a wireless link. Evaluation of the error message may preferably also be performed in the control device 20, additionally or as an alternative.

15

Similarly, the actuator 50 comprises a control and/or evaluation unit 53 which may be in the form of a microcontroller. Actuator 50 may be a robot, for example, which can receive and evaluate control data from control device 20. Control and evaluation unit 53 is connected to at least two device-internal digital memory cards 51 and 52 which redundantly store at least data for operating the actuator 50. Accordingly, these data are preferably data of a control program. The control and evaluation unit 53 is programmed so as to be able to access the data that are redundantly stored in the two memory cards 51 and 52 in such a way that the actuator 50 is able to continue to work properly even if one of the memory cards 51 or 52 fails. It should be noted that, if more than two memory cards are used, more than one of the memory cards can fail. One error-free memory card is sufficient for proper operation of the electronic device.

Memory cards 51 and 52 may additionally redundantly store device-specific data and configuration data of the actuator 50. Memory cards 51 and 52 may be SD cards. Control and evaluation unit 53 can preferably communicate with the at least two memory cards 51 and 52 via a serial bus, such as the SPI bus, or via a parallel bus. The control and/or evaluation unit 53 may appropriately furthermore be adapted to monitor the at least two memory cards 51 and 52 for errors, to detect an error, and to signal the detected error to the higher-level control unit 60, for example. In this way, the higher-level control unit 60 can in particular be notified about the failure of one of the memory cards 51 and 52. An error detected by the control and evaluation unit 53 can preferably be transmitted via field bus 30 to control device 20 and can then be forwarded to the higher-level control unit 60, for evaluation. Evaluation of the error message may preferably also be performed in the control device 20, additionally or as an alternative.

Control device 20 comprises a control and/or evaluation unit 23 which may be in the form of a microcontroller. Control device 20 may receive input data from sensor 40 and transmit output data to actuator 50, for example. Control and evaluation unit 23 is connected to at least two device-internal digital memory cards 21 and 22 which redundantly store at least data for operating the control device 20. Accordingly, these data are preferably data of a control program. Control and evaluation unit 23 is programmed so as to be able to access the data that are redundantly stored in the two memory cards 21 and 22 in such a way that the control device 20 is able to continue to work properly even if one of the memory cards 21 or 22 fails. This means that a defective memory card can also be replaced during operation. Memory cards 21 and 22 can additionally redundantly store device-specific data, parameter data, configuration data, and measurement data of the sensor 40. Memory cards 21 and 22 may be SD cards. Control and evaluation unit 23 can preferably communicate with the at least two memory cards 21 and 22 via a serial bus, such as the SPI bus, or via a parallel bus. Control and/or evaluation unit 23 may appropriately furthermore be adapted to monitor the at least two memory cards 21 and 22 for errors, to detect an error, and to signal the detected error to the higher-level control unit 60, for example. In this way, the higher-level control unit 60 can in particular be notified about the failure of one of the memory cards 21 and 22. An error detected by the control and evaluation unit 23 can preferably be transmitted to the higher-level control unit 60 via Ethernet link 70, for evaluation. Evaluation of the error message may preferably also be performed in the control device 20, additionally or as an alternative. It is also conceivable that an error detected by the control and evaluation unit 23 is evaluated and signaled in the control device 20 itself.

Since errors relating to the memory cards can be immediately reported to the higher-level memory unit 60 by the electronic devices 20, 40, and 50 connected to fieldbus 30, an operator will in particular be able to quickly and selectively replace defective memory cards in the electronic devices 20, 40, and 50 without any failure of the automation system 10.

1. An electronic device for use in an automation system comprising:
at least two device-internal digital memory cards which redundantly store data for operating the electronic device; and
a control and/or evaluation unit that is adapted to communicate with the at least two memory cards and to ensure proper operation of the electronic device even in the event of failure of one of the memory cards.

2. The electronic device of claim 1, wherein:
the electronic device is a field bus subscriber, in particular one of a control device, a bus coupler, a sensor, or an actuator.

3. The electronic device of claim 1, wherein:
the control and/or evaluation unit is adapted to monitor the at least two memory cards for errors, to detect an error, and to signal the detected error.

4. The electronic device of claim 1, wherein:
the at least two memory cards and the control and/or evaluation unit communicate with one another via a serial bus or a parallel bus.

5. The electronic device as claimed in any of the preceding claims claim 1, wherein:
the memory cards are SD memory cards.

6. An automation system, comprising:
a plurality of electronic devices, each of the electronic devices comprising:
at least two device-internal digital memory cards which redundantly store data for operating the electronic device; and
a control and/or evaluation unit adapted to communicate with the at least two memory cards and to ensure proper operation of the electronic device even in the event of failure of one of the memory cards; and
a bus system to which the electronic devices are connected.

7. The automation system of claim 6, wherein the bus system is a field bus.

8. The automation system of claim 6, wherein:
each of the electronic devices is adapted to signal a detected error relating to the at least two digital memory cards to a higher-level control unit.

9. The automation system of claim 7, wherein:
each of the electronic devices is adapted to signal a detected error relating to the at least two digital memory cards to a higher-level control unit.

10. The electronic device of claim 2, wherein:
the control and/or evaluation unit is adapted to monitor the at least two memory cards for errors, to detect an error, and to signal the detected error.
